(19) United States
(12) Patent Application Publication
(10) Pub. No.: US 2003/0082956 A1
(43) Pub. Date: May 1, 2003

(54) ELECTRICAL CONNECTION DEVICE FOR CONNECTING A MALE CONTACT TO A LOOP FORMED IN A STRIPPED CONDUCTOR

(75) Inventor: Olivier Verneau, Rueil Malmaison (FR)

Correspondence Address: GREENBLUM & BERNSTEIN, P.L.C., 1950 ROLAND CLARKE PLACE, RESTON, VA, 20191, US

(73) Assignee: Societe SYLEA, MONTIGNY LE BRETONNEUX (FR)

(21) Appl. No.: 09/983,938

(22) Filed: Oct. 26, 2001

(51) Int. Cl. H01R 4/48

(52) U.S. Cl. 439/786

(57) ABSTRACT

An electrical connection device for a male electrical contact member includes a body with a passage able to contain at one end a conductor bent to form a loop and to receive a clamp for retaining and fixing the loop. The clamp presses on an elastic pusher which presses a male member inserted into the passage against the loop.

### BACKGROUND OF THE INVENTION

1. Field of the Invention

The present invention relates to an electrical connection device for a male electrical contact member taking the form of a tongue.

2. Description of the Prior Art

Electrical connections generally use a male electrical contact member crimped to one end of an electrical conductor and adapted to be inserted into a female member in which it is retained elastically, the combination being accommodated in a passage in a housing.

This necessitates a series of relatively complex operations, and one object of the present invention is to simplify this kind of electrical connection device.

### SUMMARY OF THE INVENTION

The invention provides a device including a housing member incorporating a passage with a slot at one end for inserting a male member, and in which, at the end opposite the slot, the passage has an opening for inserting a clamp, means for guiding and means for locking the clamp being provided in the passage so that the clamp is perpendicular to the slot, the clamp taking the form of a plate having a cut-out opening onto one of its edges intended to face toward the end of the slot for inserting the male member and delimiting two branches, one of which includes a member for retaining a loop formed in a stripped conductor inserted into the passage and the other of which includes an elastic pusher adapted to press the male member against the loop in the conductor.

This kind of device is inexpensive, easy to use and quick to fit because it suffices to insert the loop and then the clamp into the passage to produce a female electrical contact member.

According to one constructional feature, the housing member has, in the passage and in the vicinity of the end with the slot for inserting the male member, an abutment for retaining the loop in the conductor and the shoulder of the corresponding branch of the clamp faces toward the abutment. Thus fitting and fixing the loop in the conductor in the passage are particularly simple.

To press the male member engaged between the branches of the clamp against the loop with some force, the branch constituting the elastic pusher has, on the same side as the other branch, a boss that is higher up than the shoulder of the other branch.

According to another constructional feature, the passage in the housing member includes at least one catch adapted to cooperate with the edge of the plate constituting the clamp opposite that onto which the cutout opens.

According to another feature, the passage includes two first grooves for guiding the conductor and two grooves for guiding the clamp in a plane perpendicular to the first grooves.

Finally, the clamp can be made from an elastic material that is a good conductor of electricity.

The invention will now be described in more detail with reference to one particular embodiment provided by way of example only and shown in the accompanying drawings.

### BRIEF DESCRIPTION OF THE DRAWINGS

FIG. 1 is a perspective view of a device in accordance with the invention.

FIG. 2 is an exploded perspective view of the device shown in FIG. 1.

FIG. 3 is a partly cut away perspective view of the assembled device.

FIG. 4 is a view in section taken along the line 4-4 in FIG. 6.

FIG. 5 is a view in section taken along the line 5-5 in FIG. 6.

FIG. 6 is a view in section taken along the line 6-6 in FIG. 5.

FIG. 7 is a sectional view corresponding to FIG. 6, showing the male member inserted into the clamp.

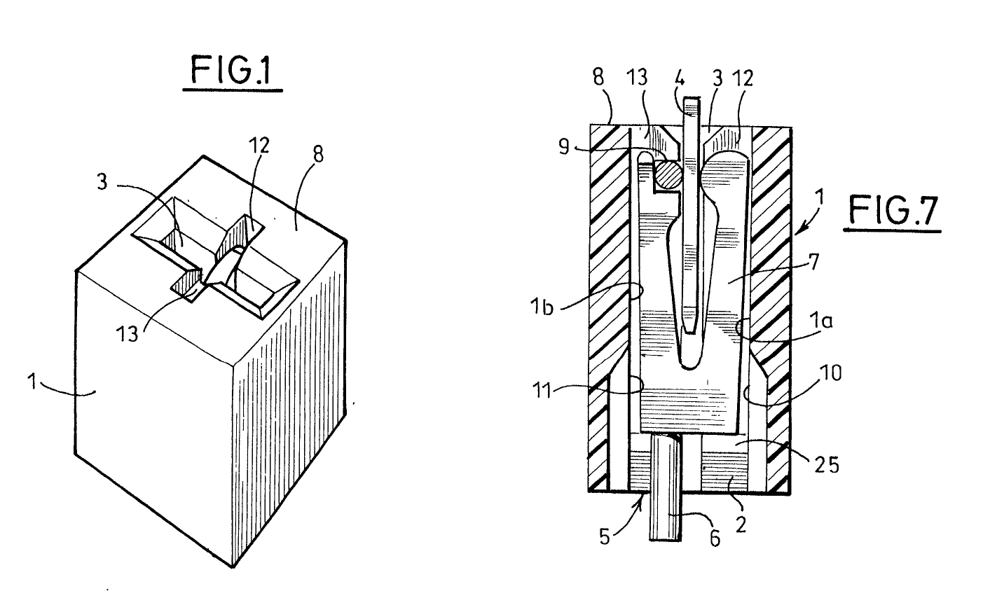

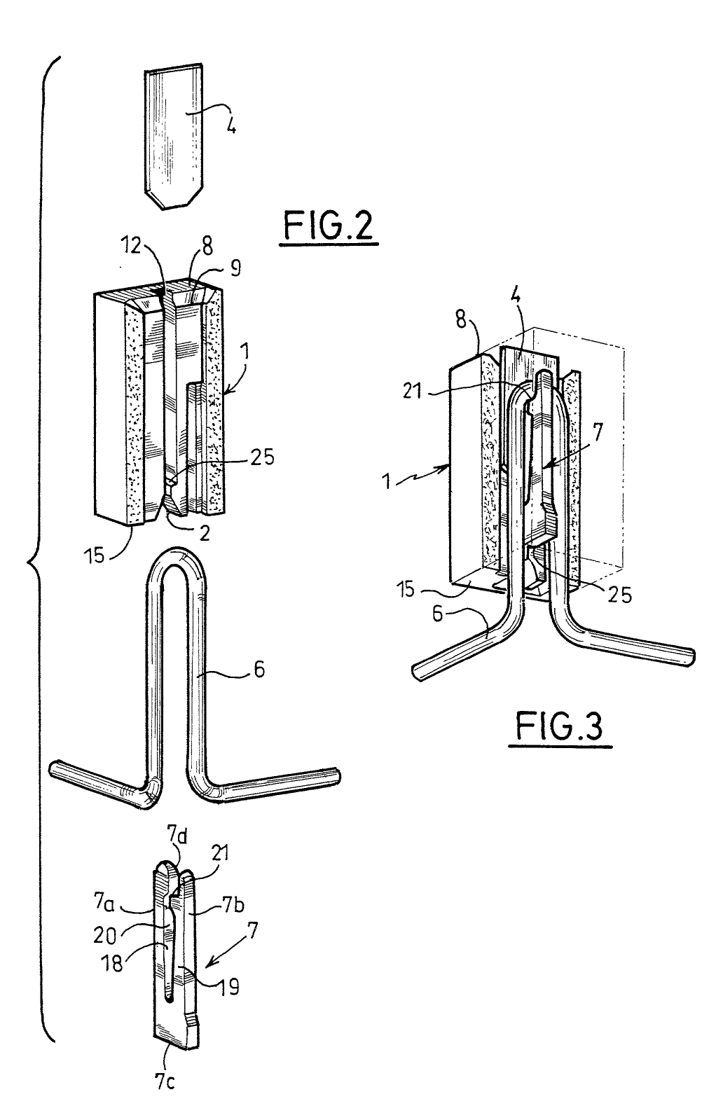

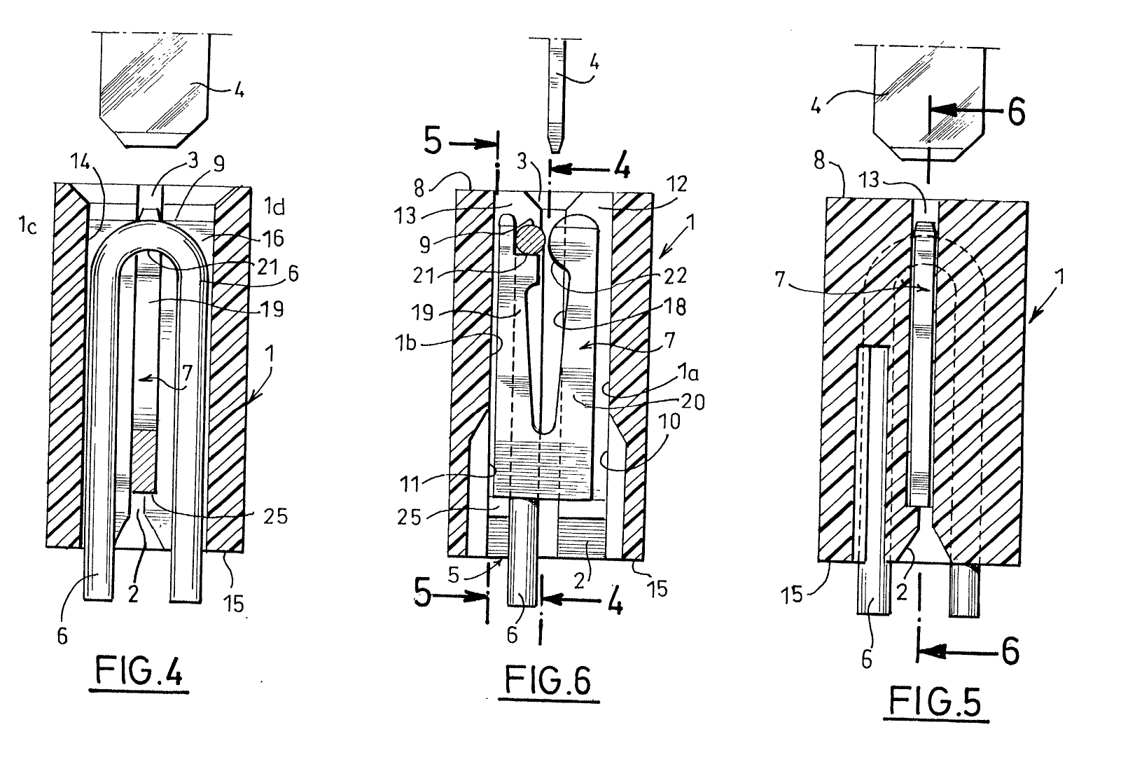

### DETAILED DESCRIPTION OF THE PREFERRED EMBODIMENT

The connection device shown in the figures includes a housing member 1 pierced by a passage 2 having at one end 8 a slot 3 for inserting a male tongue 4 and at the other end 15 an opening 5 for inserting a conductor 6 and a clamp 7.

The passage 2 has grooves 10 and 11 for the clamp 7 on two opposite inside walls 1a and 1b and opening into openings 12 and 13 at the end 8, which incorporates abutments 9.

Grooves 14 and 16 for guiding the conductor 6 on the other two inside walls 1c and 1d of the passage 2 are situated in a common plane perpendicular to a plane passing through the grooves 10 and 11.

The clamp 7 consists of a plate of an elastic material, possibly a material that is a good conductor of electricity, such as a metal or a plastics material, and has a generally rectangular shape with two longer sides 7a and 7b and two shorter sides 7c and 7d. A cut-out 18 extending from the shorter side 7d delimits two branches 19 and 20. The branch 19 has a shoulder 21 near its free end and the branch 20 constitutes an elastic pusher and has a boss 22 near its free end and higher up than the shoulder 21.

The depth of the shoulder 21 is less than the section of the stripped conductor 6 and the boss 22, when in its relaxed position, is in the vicinity of the conductor 6.

Two catches 25 for immobilizing the clamp 7 in the grooves 10 and 11 are molded at the end 15 of the housing member 1.

As shown in the figures, the conductor 6 is bent in two to form a U-shaped loop, the outside face of the core of the U-shape bearing against the abutments 9. The clamp 7 is inserted from the end 15 into the grooves 10 and 11, the loop of the conductor 6 cooperates with the shoulder 21, and said clamp 7 is immobilized by the catches 25, which bear against the edge of the shorter side 7c.

Note that the distance between the bottoms of the grooves 10 and 11 is slightly greater than the width of the clamp 7 so that there is some elastic play between the branches 19 and 20 when the tongue 4 inserted into the slot 3 lies between the loop in the conductor 6 and the boss 22.

The figures show a unitary housing member, but the housing could take the form of a body including a series of passages 2.

Of course, the invention is not limited to the embodiment just described and shown, to which many modifications of detail can be made without departing from the scope of the invention.

There is claimed:

1. An electrical connection device for a male electrical contact member such as a tongue, which device includes a housing member incorporating a passage with a slot at one end for inserting said male member, and in which device, at the end opposite said slot, said passage has an opening for inserting a clamp, means for guiding and means for locking said clamp being provided in said passage so that said clamp is perpendicular to said slot, said clamp taking the form of a plate having a cut-out opening onto one of its edges intended to face toward the end of said slot for inserting said male member and delimiting two branches, one of which includes a member for retaining a loop formed in a stripped conductor inserted into said passage and the other of which includes an elastic pusher adapted to press said male member against said loop in said conductor.

2. The electrical connection device claimed in claim 1, wherein said housing member has, in said passage and in the vicinity of the end with said slot for inserting said male member, an abutment for retaining said loop in said conductor and said shoulder of the corresponding branch of said clamp faces toward said abutment.

3. The electrical connection device claimed in claim 1, wherein said branch constituting said elastic pusher has, on the same side as said other branch, a boss that is higher up than said shoulder of said other branch.

4. The electrical connection device claimed in claim 1, wherein said passage in said housing member includes at least one catch adapted to cooperate with the edge of said plate constituting said clamp opposite that onto which said cut-out opens.

5. The electrical connection device claimed in claim 1, wherein said passage includes two first grooves for guiding said conductor and two grooves for guiding said clamp in a plane perpendicular to said first grooves.

6. The electrical connection device claimed in claim 1, wherein said clamp is made from an elastic material that is a good conductor of electricity.
